(19) United States
(12) Patent Application Publication
(10) Pub. No.: US 2016/0230013 A1
(43) Pub. Date: Aug. 11, 2016

(54) BUILDING PANEL WITH MAGNESIUM OXIDE-PHOSPHATE BACKCOATING

(71) Applicant: USG Interiors, LLC, Chicago, IL (US)

(72) Inventors: Mark H. Englert, Libertyville, IL (US); Lee K. Yeung, Garland, TX (US)

(21) Appl. No.: 14/619,317

(22) Filed: Feb. 11, 2015

(51) Int. Cl. C09D 1/00; B05D 3/00

(52) U.S. Cl. CPC C09D 1/00; B05D 3/007

(57) ABSTRACT

Methods for making building panels are described. The methods include combining water, an inorganic fiber, and one or more binders to form a slurry, wherein at least one of the binders comprises starch; shaping the slurry into a panel; applying a coating to a back side of the panel, the coating comprising a reaction product of magnesium oxide and a phosphate salt in the absence of an amino alcohol; and drying the panel. Building panels are also described.

### BACKGROUND

Panels used as ceiling tiles or walls fall into the category of building products and provide architectural value, acoustical absorbency, acoustical attenuation and utility functions to building interiors. Commonly, panels, such as acoustical panels, are used in areas that require noise control. Examples of these areas are office buildings, department stores, hospitals, hotels, auditoriums, airports, restaurants, libraries, classrooms, theaters, cinemas, as well as residential buildings.

To provide architectural value and utility functions, an acoustical panel, such as a ceiling panel for example, is substantially flat and self-supporting for suspension in a typical ceiling grid system or similar structure. Thus, acoustical panels possess a certain level of hardness and rigidity, which is often measured by its modulus of rupture (“MOR”). To obtain desired acoustical characteristics, an acoustical panel also possesses sound absorption as well as sound transmission reduction properties.

Currently, most acoustical panels or tiles are made using a water felting process preferred in the art due to its speed and efficiency. In a water-felting process, the base mat is formed utilizing a method similar to papermaking. One version of this process is described in U.S. Pat. No. 5,911,818 issued to Baig, herein incorporated by reference. Initially, an aqueous slurry including a dilute aqueous dispersion of mineral wool, lightweight aggregate, fibers, binders and other additives is delivered onto a moving foraminous wire of a Fourdrinier-type mat forming machine. Water is drained by gravity from the slurry and then optionally further dewatered by means of vacuum suction and/or by pressing. Next, the dewatered base mat, which may still hold some water, is dried in a heated oven or kiln to remove the residual moisture. Panels of acceptable size, appearance and acoustic properties are obtained by finishing the dried base mat. Finishing includes surface grinding, cutting, perforation/fissuring, roll/spray coating, edge cutting and/or laminating a scrim or veil onto the panel.

A typical acoustical panel base mat composition includes inorganic fibers, cellulosic fibers, binders, and fillers. As is known in the industry, inorganic fibers can be either mineral wool (which is interchangeable with slag wool, rock wool and stone wool) or fiberglass. Mineral wool is formed by first melting slag and minor additives at 1300° C. (2372° F.) to 1650° C. (3002° F.). The molten mineral is then spun into wool in a fiberizing spinner via a continuous air stream. Inorganic fibers are stiff, giving the base mat bulk and porosity.

Cellulosic fibers act as structural elements, providing both wet and dry basemat strength. The strength is due to the formation of countless hydrogen bonds with various ingredients in the base mat, which is a result of the hydrophilic nature of the cellulosic fibers.

A typical base mat binder used is starch. Typical starches used in acoustical panels are unmodified, uncooked corn or wheat starch granules that are dispersed in the aqueous slurry and distributed generally uniformly in the base mat. Once heated in the presence of moisture during the drying process, the starch granules become cooked and dissolve, providing binding ability to the panel ingredients. Starches not only assist in the flexural strength of the acoustical panels, but also for hardness and rigidity of the panel. In certain panel compositions having a high concentration of inorganic fibers, a latex binder is used as the primary or as a secondary binding agent.

Typical base mat fillers include lightweight inorganic materials. A primary function of lightweight fillers is to provide bulking within the mat, thus providing a lower density and lighter weight ceiling panel. An example of a lightweight filler includes expanded perlite. Even though the term “filler” is used throughout this disclosure, it is to be understood that each filler has unique properties and/or characteristics that can influence the rigidity, hardness, sag, sound absorption, and reduction in the sound transmission in panels. Heavyweight fillers can also be added, and include calcium carbonate, clay, or gypsum, for example.

Wet felted ceiling products typically utilize starch and recycled newsprint as the principal binders, both of which are hygroscopic. In the presence of humidity, these binders absorb water and lose physical integrity, leading to sag. Some existing products use a formaldehyde resin backcoating. Although this is a very effective and low cost solution, there has been a move to reduce or eliminate the use of formaldehyde in building products for environmental reasons.

Thermoset polymer resins, such as polycarboxylate resins, have been used successfully. See e.g., U.S. Pat. No. 8,536,259. However, these resins are too expensive to be commercially viable.

U.S. Pat. No. 4,444,594 describes the use of acid cured compositions which are produced by reacting magnesium oxide and an acid phosphate, chloride, or sulfate salt in the presence of inorganic filler, an amino alcohol acid attack control agent, and water to form a curable slurry. The amino alcohol acid attack control agent is said to be required to prevent the degradation of mineral wool used in ceiling boards. However, the required use of the amino alcohol acid attack agent increases the cost of the coating and contributes unnecessary VOC's to the coating. When present as an amino compound, the inclusion of this weak base slows the reaction rate. Furthermore, the compositions contain between 50.5% and 57.9% solids.

Therefore, there is a need for a sag resistant acoustical panel which is low cost and which does not contain formaldehyde or amino alcohols.

### SUMMARY OF THE INVENTION

One aspect of the invention is a method for making a building panel. In one embodiment, the method includes combining water, an inorganic fiber, and one or more binders to form a slurry, wherein at least one of the binders comprises starch; shaping the slurry into a panel; applying a coating to a back side of the panel, the coating comprising a reaction product of magnesium oxide and a phosphate salt in the absence of an amino alcohol; and drying the panel.

Another aspect of the invention involves a building panel. In one embodiment, the building panel includes a base mat comprising an inorganic fiber, and one or more binders, wherein at least one of the binders comprises starch; and a coating on a back side of the base mat, the coating being the reaction product of magnesium oxide and a phosphate salt.

### BRIEF DESCRIPTION OF THE DRAWINGS

FIG. 1 is a graph showing the temperature rise of different sources of MgO as a function of time.

FIG. 2 is a graph showing the temperature rise as a function of time for coatings having different solids content.

FIG. 3 is a graph showing the temperature rise as a function of time for coatings containing a hectorite clay thickener.

FIG. 4 is a graph showing the temperature rise as a function of time for coatings incorporating a fly ash filler at varying usage levels.

FIG. 5 is a graph showing the temperature rise as a function of time for coatings with a fly ash filler and phosphoric acid.

FIG. 6 is a graph showing the temperature rise of coatings using varying levels of phosphoric acid and differing water/solids ratios as a function of time.

### DETAILED DESCRIPTION OF THE INVENTION

The invention meets the need for a cost-effective, non-formaldehyde containing sag resistant coating for use with ceiling tile. The coating is inorganic, fast reacting, and low cost, and it provides a high level of sag resistance. The coating is the reaction product of magnesium oxide and a phosphate. One advantage of the magnesium oxide/phosphate coating is the controllable high rate of reaction, which allows for faster processing speed for producing the ceiling tile.

The ceiling tile product process is a high speed operation, with finishing line speeds of over 150 ft/min. In order for a coating to be compatible with these line speeds, it has to cure in under 20 to 30 sec. In addition, after application, it needs to maintain its integrity during subsequent operations including a relatively high temperature drying operation in which the back of the surface of the panel reaches a temperature of about 204° C. (400° F.).

The magnesium oxide/phosphate coating can be made to react in under 30 sec and it forms an inorganic glass which is stable to high temperature.

The main components of the inorganic coating are a high reactivity magnesium oxide and a phosphate salt and optional filler. The magnesium oxide is commercially available is different grades of reactivity. Reactivity is typically based on surface area, which is the result of the burning temperature at which the magnesium oxide is produced. The higher the surface area, the higher is the reactivity. Suitable high reactivity magnesium oxide includes, but is not limited to, MagChem 10CR, MagChem 30, MagChem 35, MagChem 40, and MagChem 50 (available from Martin Marietta) and Baymag 30 and Baymag 40 (available from Baymag Inc.) and equivalents. More reactive grades of MgO can be used to provide a faster reaction rate to accommodate faster finishing line speeds, if desired. The gauge of reactivity for MgO is generally given by the measured surface area in m²/g. Lab work was conducted using a very low reactivity grade of MgO such as the MagChem 10CR product (est. <20 m²/g surface area) in order to provide handling time. In production, it would be expected that a more reactive grade of MgO would be required to provide the required quick set time of less than 30 seconds such as the MagChem 30 product (20-30 m²/g), MagChem 30 product (30 m²/g) or an even more reactive grade of MgO.

The phosphate salt is the second component. The phosphate salt should be slightly soluble in water which aids the reaction and should be slightly acidic. Suitable phosphate salts include, but are not limited to, potassium phosphate salt (KH₂PO₄), and sodium phosphate (NaH₂PO₄). However, the sodium phosphate products yielded a softer reaction product that was less suitable for this application than those made with potassium phosphate. Phosphate salts which are insoluble in water (e.g., Ca₃(PO₄)₂ and Li₃PO₄), tend to react too slowly, while those that are too soluble (e.g., LiH₂PO₄ and K₂HPO₄) tend to form dispersed precipitates.

Phosphates that are not slightly acidic, such K₃PO₄, react too slowly. Highly acidic phosphates, such as phosphoric acid, can provide a very rapid reaction rate resulting in a highly dispersed reaction product that is unsuitable for this application. Phosphoric acid can, however, can be added at a judicious level as an accelerator to provide a faster reaction rate. The amount of added phosphoric acid is dictated by such factors as the desired reaction rate, the presence of filler or thickeners which by themselves might act to slow the reaction rate, the water/solids ratio, the temperature of the mix, etc.

Ammonium phosphates such as (NH₄)H₂PO₄ and (NH₄)₂HPO₄ can also be used as reactants although they are less preferable since they evolve ammonia gas as a reaction product, which is undesirable in a production environment.

A filler or a functional additive is an optional third component of the coating. The filler ideally should be slightly soluble in water thus permitting it to react with the phosphate salt and become an integral part of the reaction product. Fillers that meet this requirement include Type C fly ash. Other non-reactive fillers, such as sand, can also be used but do not generally participate in the reaction. Basic fillers such as calcium carbonate are to be avoided. Functional additives include thickeners, such as smectite clay, flow aids, retarders, and the like.

Additional acid, such as phosphoric acid, can be added to accelerate the reaction rate by providing a more acidic environment to the reaction. The use of the acid can also be used to offset a less acidic phosphate salt such as K₂HPO₄ or K₃PO₄.

The molar ratio of the magnesium oxide to the phosphate salt in the coating can vary from about 0.1 to about 0.9, or about 0.1 to about 0.8, or about 0.1 to about 0.7, or about 0.1 to about 0.6, or about 0.1 to about 0.5, or about 0.1 to about 0.4, or about 0.1 to about 0.3. A molar ratio of about 0.3 provides good results.

The reaction of the magnesium oxide and the phosphate salt can be accelerated by the addition of an acid, such as phosphoric acid.

It was surprisingly found that the magnesium oxide/phosphate coating does not degrade the mineral wool in the ceiling panel. Thus, the use of the amino alcohol taught in U.S. Pat. No. 4,444,594 is not required, making the coating less expensive with no or minimal VOC's and easier to make.

The magnesium oxide and phosphate salt can be prepared as separate dispersions and then combined and applied uniformly across the back surface of the panel, for example by spraying. Alternatively, they can be applied over only portions of the back, for example in stripes, to achieve a reinforcing backbone along the center of a panel.

The amount of water used in preparing these coatings is desirably minimized. It has been found that more water in the coating leads to a slower reaction time, which is undesirable in a production setting where a very fast reaction time (under 30 seconds) is required. Typically, a total water/solids ratio of under about 0.5, or under about 0.45, or under about 0.4 is desired. Desirably, the coating has at least about 50% solids, or at least about 55% solids, or at least about 60% solids.

The coating will typically be applied at a solids usage of under 25 grams of solids per square foot. Usage rates of under 20 grams of solids per square foot have been shown to provide good results.

When the coating is applied to the surface of the panel, there is some penetration into the panel, e.g., up to about 5% of the thickness of the panel. The coating has good adhesion to the panel.

Fibers are present in the acoustical panel as inorganic fibers, organic fibers or combinations thereof. Inorganic fibers can be mineral wool, slag wool, rock wool, stone wool, fiberglass or mixtures thereof. The inorganic fibers are stiff, giving the base mat bulk and porosity. Inorganic fibers are present in the acoustical panel in amounts of about 0% to about 95% based on the weight of the panel. In some embodiments, where less expanded perlite and/or cellulosic fiber is present, the inorganic fibers are present in an amount of about 25% to about 95%, or about 50% to about 95%, or about 55% to about 95%, or about 60% to about 95%, or about 65% to about 95%, or about 70% to about 95%, or about 75% to about 95% or about 80% to 95%. In other embodiments, where more expanded perlite and/or cellulosic fibers are present, the amount of inorganic fibers can be in the range of about 5% to about 90%, or about 5% to about 80%, or about 5% to about 70%, or about 5% to about 60%, or about 5% to about 50%, or about 5% to about 40%, or about 5% to about 30%, or about 5% to about 25%, or about 5% to about 20%. At least one embodiment of the acoustical panel uses mineral wool as the preferred fiber.

Cellulosic fibers, an example of a renewable organic fiber, act as structural elements providing both wet and dry base mat strength. The strength is due to the formation of hydrogen bonds with various ingredients in the base mat, which is a result of the hydrophilic nature of the cellulosic fibers. Cellulosic fibers in the base mat range from about 0% to about 25% by weight of the panel, preferably about 10% to about 20% by weight of the panel and most preferably from about 12% to about 20% by weight of the panel. One preferred cellulosic fiber is derived from recycled newsprint.

Starch is optionally included in the base mat as a binder. Typical starches are unmodified, uncooked starch granules that are dispersed in an aqueous slurry and become distributed generally uniformly through the base mat. The base mat is heated in the presence of moisture, cooking and dissolving the starch granules to bind the panel ingredients together. Starch not only assists in the flexural strength of the acoustical panels, but also improves the hardness and rigidity of the panel. In addition, the base mat optionally includes starches in the range of about 1% to about 15% by weight of the panel, more preferably from about 5% to about 10% and most preferably from about 7% to about 10% by weight of the panel.

Typical optional base mat fillers include both lightweight and heavyweight inorganic materials. Examples of heavyweight fillers include calcium carbonate, clay or gypsum. Other fillers are also contemplated for use in the acoustical panels. The ball clay can also be used in the range of about 0% to about 4% by weight of the panel.

An example of a lightweight filler is expanded perlite. Expanded perlite is bulky, reducing the amount of filler used in the base mat. Primary functions of the filler are reduced density, improved flexural strength and hardness of the panel. Even though the term “filler” is used throughout this discussion, it is to be understood that each filler has unique properties and/or characteristics that can influence the rigidity, hardness, sag, sound absorption and reduction in the sound transmission in panels. The expanded perlite in the base mat of this embodiment is present in amounts ranging from about 5% to about 80% by weight of the panel, or about 10% to about 80%, or about 20% to about 80%, or about 20% to about 70%, or about 30% to about 70%, or about 40% to about 70%, or about 40% to about 60%, or about 45% to about 60%.

Another optional ingredient used in fire rated acoustical panels is clay, which is typically included to improve fire resistance. When exposed to fire, the clay does not burn; instead, it sinters. Fire rated acoustical panels optionally include from about 10% to about 30% clay by weight of the panel, with a preferred range of about 10% to about 20% clay by weight of the panel. Many types of clay are used including but not limited to Spinks Clay and Ball Clay from Gleason, Tenn. and Old Hickory Clay from Hickory, Ky.

A flocculant is also typically added to the furnish used in producing acoustical panels. The flocculant is preferably added as a very dilute solution and is used in the range of about 0.05% to about 0.15% by weight of the panel and more preferably from about 0.05% to about 0.10% by weight of the panel. Useful flocculants include polyacrylamides.

In one embodiment of making base mats for the acoustical panels, an aqueous slurry is preferably created by mixing water with the mineral wool, expanded perlite, cellulosic fibers, starch, and ball clay. Mixing operations are preferably carried out in a stock chest, either in batch modes or in continuous modes. The amount of added water is such that the resultant total solid content or consistency is in the range of about 1% to about 8% consistency, preferably from about 2% to about 6% and more preferably from about 3% to about 5%.

Once a homogeneous slurry including the above-mentioned ingredients is formed, the flocculant is added in-line and the slurry is transported to a headbox, which provides a steady flow of the slurry material. The slurry flowing out of the headbox is distributed onto a moving foraminous wire to form the wet base mat. Water is first drained from the wire by gravity. It is contemplated that in certain embodiments, a low vacuum pressure may be used in combination with, or after draining water from the slurry by gravity. Additional water is then optionally removed by pressing and/or using vacuum-assisted water removal, as would be appreciated by those having ordinary skill in the art.

Once formed, the formed base mats preferably have a bulk density between about 7 lbs/ft³ (112 kg/m³) and about 30 lbs/ft³ (480 kg/m³), more preferably between about 8 lbs/ft³ (128 kg/m³) to about 25 lbs/ft³ (400 kg/m³) and most preferably from about 10 lbs/ft³ (144 kg/m³) to about 20 lbs/ft³ (320 kg/m³).

The formed base mat is then cut and converted into the acoustical panel through finishing operations as are well known by those having ordinary skill in the art. Some of the preferred finishing operations include, among others, surface grinding, coating, perforating, fissuring, edge detailing and/or packaging.

A magnesium oxide/phosphate coating is applied during the finishing operation either as a combined MgO-phosphate dispersion or as individual dispersions applied in rapid succession. If applied as a combined dispersion, it would be necessary that the individual MgO and phosphate components be combined just prior to their application to the back surface of the panel.

Perforating and fissuring contribute significantly to achieving improved acoustical absorption value from the above-described base mats. Perforating operations provide multiple perforations on the surface of a base mat at a controlled depth and density (number of perforations per unit area). Perforating is carried out by pressing a plate equipped with a predetermined number of needles onto a base mat. Fissuring provides shallow indentation of unique shapes onto the surface of a formed base mat with, for example, a roll equipped with a patterned metal plate. The perforating and fissuring steps both open the base mat surface and its internal structure, thereby allowing air to move in and out of the panel. Openings in the base mat also allow sound to enter and be absorbed by the base mat core.

In addition, the acoustical panels are optionally laminated with a scrim or veil. It is also contemplated that the present acoustical panels can be manually cut with a utility knife.

Once formed, the present finished acoustical panels preferably have a bulk density between about 9 lbs/ft³ (144 kg/m³) and about 32 lbs/ft³ (513 kg/m³), more preferably between about 10 lbs/ft³ (160 kg/m³) to about 27 lbs/ft³ (433 kg/m³) and most preferably from about 10 lbs/ft³ (176 kg/m³) to about 22 lbs/ft³ (352 kg/m³). In addition, the panels preferably have a thickness between about 0.2 inches (5 mm) and 1.5 inches (38 mm), more preferably between about 0.3 inches (8 mm) to 1.0 inch (25 mm) and most preferably from about 0.5 inches (13 mm) to about 0.75 inches (19 mm).

By about, we mean within 10% of the value, or within 5%, or within 1%.

### EXAMPLES

### Example 1

10.0 grams of MgO was measured into a cup. 10.0 grams of KH₂PO₄ and 10.0 grams of water were measured into a separate cup and stirred to dissolve the phosphate. The solid MgO was added to the KH₂PO₄ and water mixture, and mixed. The temperature rise of the mixture was measured using a thermocouple. The mixtures are shown in Table 1.

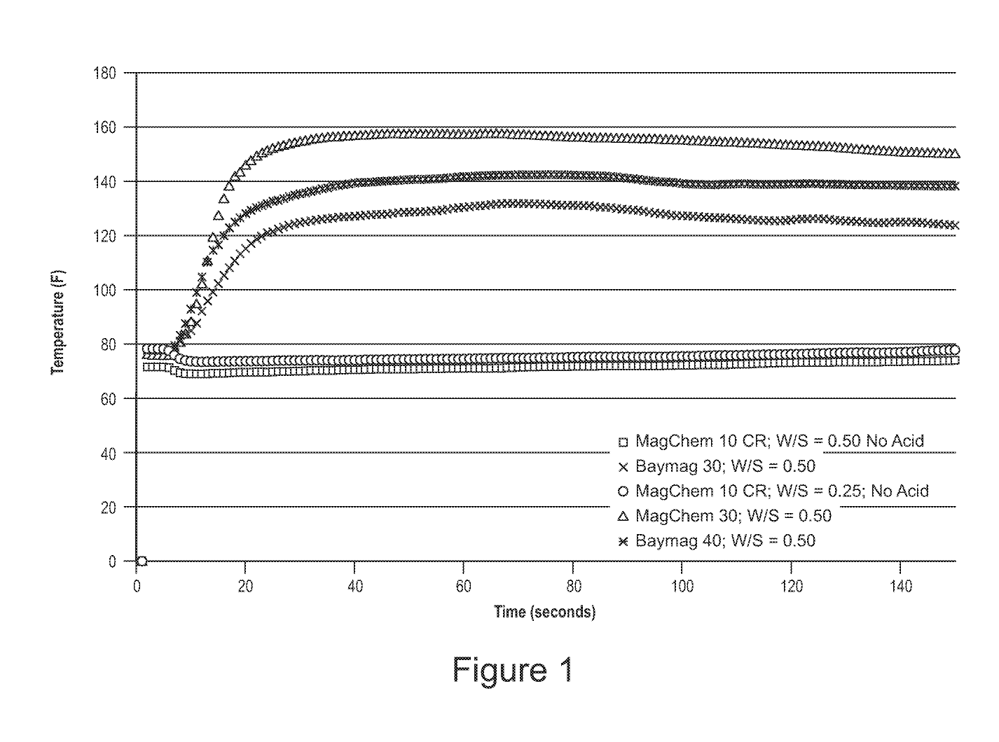

The results are shown in FIG. 1. In Trial 1 using MagChem 10 CR, there was no apparent reaction after 2 min, although there was an apparent setting after about 60 min. There was a very rapid reaction in Trial 2 using MagChem 30, with setting in under 5 sec and a hard reaction product. Trial 3 using Baymag 30 had a very rapid reaction with steam generation and a hard reaction product. Trial 4 using Baymag 40 showed a very rapid reaction with steam generation and a hard reaction product. Trial 5 using MagChem 10 CR but at a lower water/solids ratio had a slow reaction but gradual heating occurred, and a hard reaction product formed.

The MagChem 10 product appears to be quite unreactive showing no setting at an m value of 0.3 and a water/solids (W/S) ratio of 0.5. After more than 60 min, the mixture did harden. Lowering the W/S ratio to a value of 0.25 (i.e., less water) appeared to slightly speed up the reaction. After more than 60 min, this mixture also hardened.

The MagChem 30 product appears to be highly reactive, even more reactive than the Baymag 30 and Baymag 40 products.

### Example 2

The effect of the amount of water on the reaction rate was studied. KH₂PO₄ and water were measured into a cup. MgO (BayMag 40) was measured separately and then added to the KH₂PO₄ and water mixture, and mixed. The temperature rise of the mixture was measured using a thermocouple. The mixtures are shown in Table 2 with each mixture being run twice.

The Trial 1 formulations appeared to harden within seconds.

The solids in the Trial 2 formulations segregated to the bottom and set up. The top remained soft after 5 min.

The solids in the Trial 3 formulations segregated to the bottom leaving excess water on the surface. A thin layer of bottoms solids did set up to some degree.

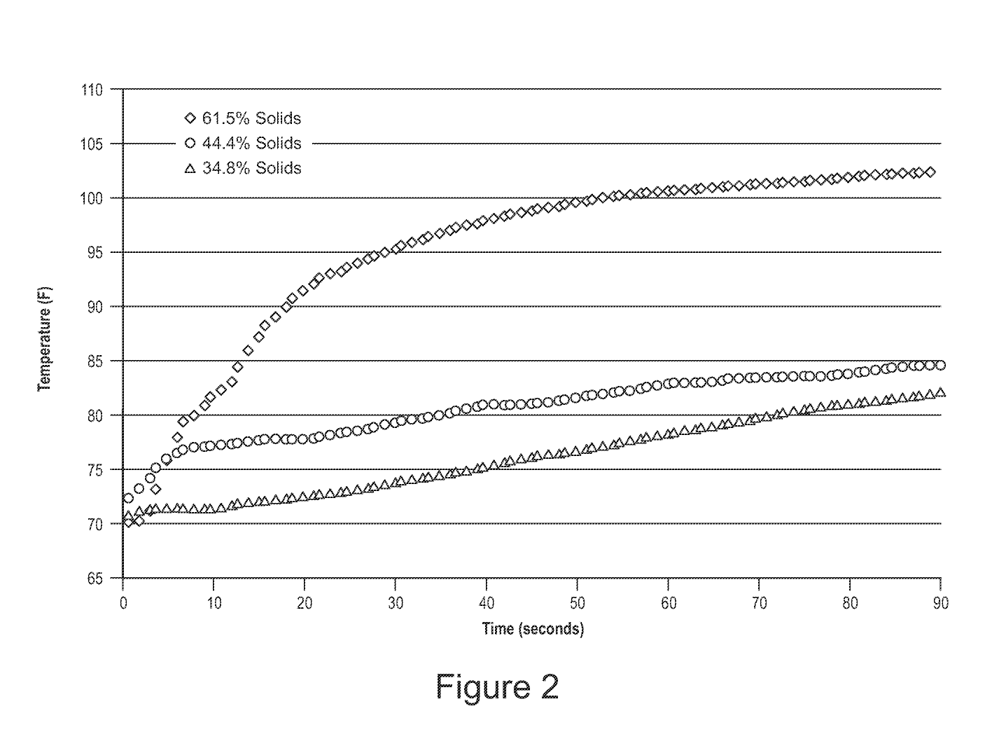

The results are shown in FIG. 2. When the sample has less than about 50% solids, the reaction is too slow for production speeds.

### Example 3

The use of a thickener, hectorite clay, in the formulations was evaluated. The required amount of hectorite clay (Bentone GS available from Elementis Specialties) was mixed in water using a high speed mixer for 10 minutes in order to achieve either a 0.5% or 1.0% Bentone CS dispersion as required below. 5 grams of KH₂PO₄ and 5.0 grams of the appropriate water/clay mixture were measured into a cup. 5 grams of MgO (Baymag 40) was measured separately and then added to the KH₂PO₄ and water/clay mixture, and mixed. The temperature rise of the mixture was measured using a thermocouple. The mixtures are shown in Table 3.

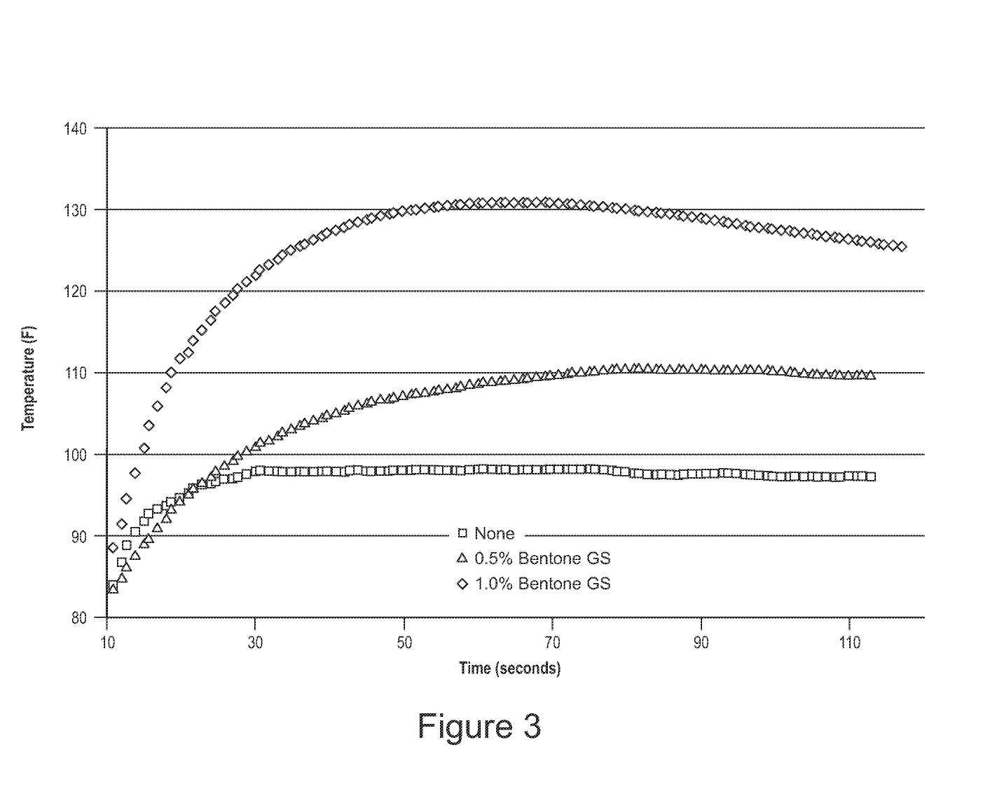

The presence of the clay thickener accelerated the reaction as shown in FIG. 3.

### Example 4

The use of filler in the formulations was evaluated. The filler was a Type C fly ash from Hugo.

The KH₂PO₄ and water were measured into a cup. MgO (Baymag 40) was measured separately and then added to the KH₂PO₄ and water/clay mixture, and mixed. The temperature rise of the mixture was measured using a thermocouple. The mixtures are shown in Table 4.

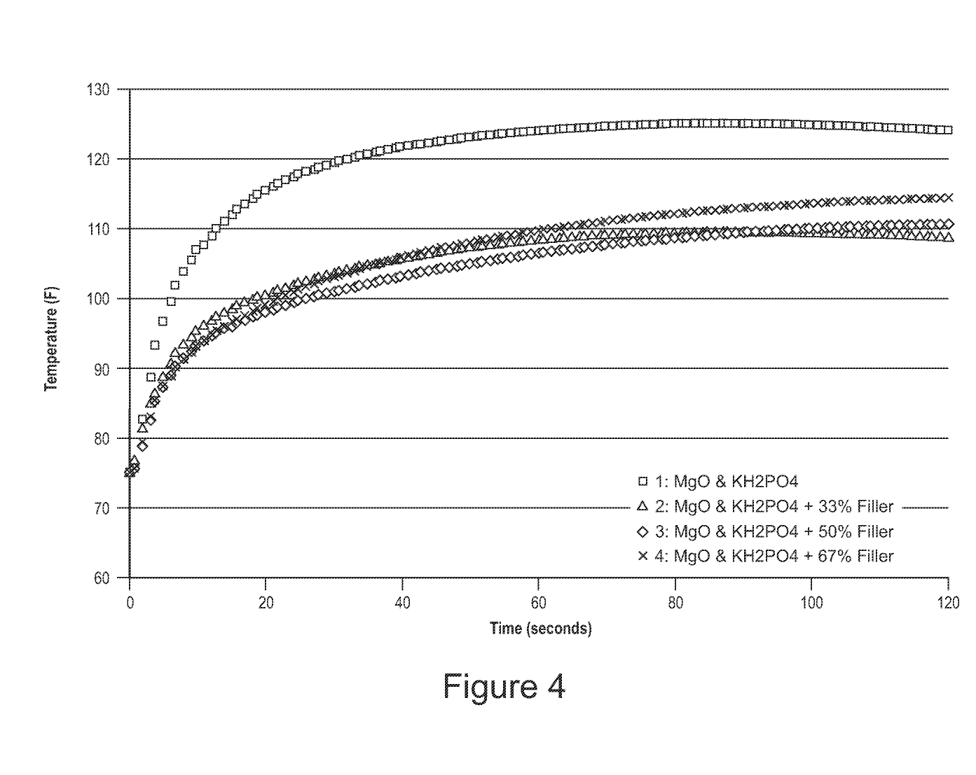

The presence of up to 67% fly ash did not have a noticeable effect on the rate of reaction as shown in FIG. 4. All of the resulting products were quite hard.

### Example 5

The use of filler and acid in the formulations was evaluated.

The required amount of hectorite clay (Bentone GS available from Elementis Specialties) was mixed in water using a high speed mixer for 10 minutes in order to achieve a 2.0% Bentone CS dispersion. In trial 1 utilizing 33% filler, 10.0 grams of KH₂PO₄, and 6.0 grams of the water/clay mixture were measured into a cup. 10.0 grams of MgO (Baymag 40), 10.0 grams of filler (type C fly ash from Hugo), and 10.0 grams of water/clay mixture was measured separately, and the mixture was added to the KH₂PO₄, acid and water/clay mixture, and mixed. The temperature rise of the mixture was measured using a thermocouple. In trial 2 using 50% filler, 10.0 grams of KH₂PO₄, and 6.0 grams of the water/clay mixture and 0.5 ml of 85% H₃PO₄ (only for trial 2) were measured into a cup. 10.0 grams of MgO (Baymag 40), 20.0 grams of filler (type C fly ash from Hugo), and 10.0 grams of water/clay mixture was measured separately, and the mixture was added to the KH₂PO₄, acid and water/clay mixture, and mixed. The temperature rise of the mixture was again measured using a thermocouple. The results are shown in Table 5.

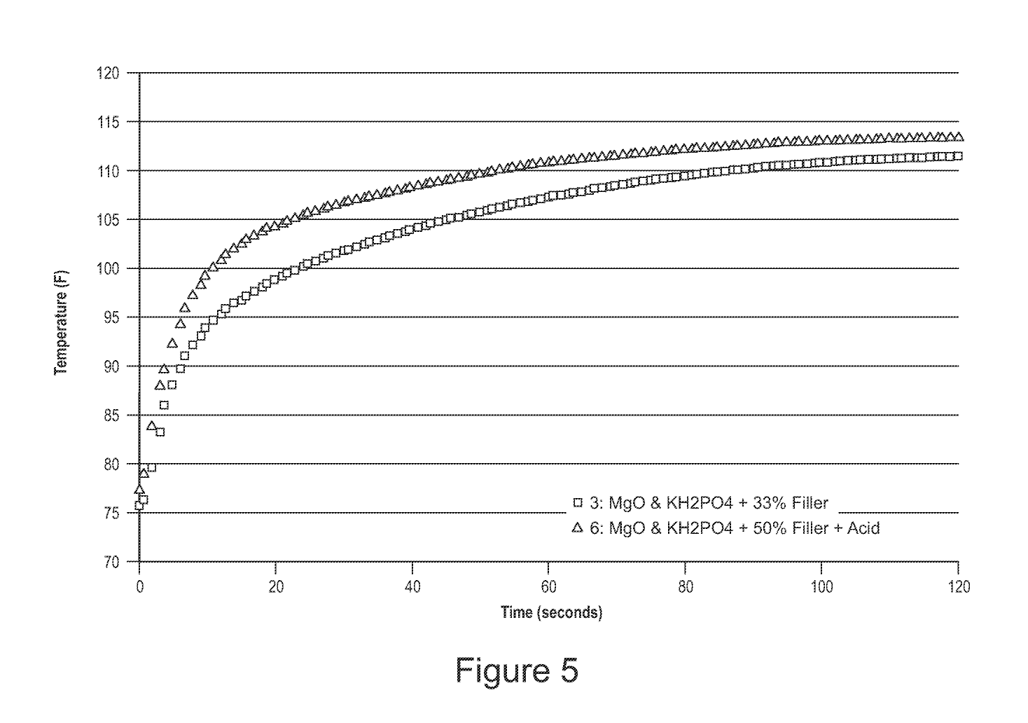

The results of this study demonstrate that even in the presence of significant levels of filler, the addition of phosphoric acid is effective in accelerating the reaction rate to the levels necessary for production as shown in FIG. 5.

### Example 6

Perforated and patterned test strips (3 in.×23.75 in.) were prepared. Perforating refers to pressing a plate equipped with a predetermined number of needles into the base mat, while patterning provides shallow indentation of unique shapes into the surface of the basemat. The use of a perforated and patterned test strip provides a more realistic indicator of the potential sag resistance performance of a backcoating. The weight of each test panel was recorded. The edges of the test panels were taped.

KH₂PO₄ and water were measured into a cup and stirred to eliminate lumps. MgO (Baymag 30) was measured separately and then added to the KH₂PO₄ and water mixture and immediately poured across the top of the sag strip. Excess material was removed with a spatula. Samples 7-10 used 2% clay thickener (Bentone GS) in the water mixed with the KH₂PO₄. The mixtures are shown in Table 6.

The test panels were allowed to dry overnight at room temperature. The tape was then removed, and the panels were weighed and tested for sag performance by suspending the panels in a test rack such that only the short edges were supported. The test panels were then subjected to three cycles of 12 hours of 104° F./95% RH followed by 12 hours of 70° F./50% RH conditioning.

The sag performance is shown in Table 7.

Test panels 11 through 15 are un-backcoated test strips and are included as controls.

In all three series (i.e., low water/solids ratio, medium water/solids ratio, and high water/solids ratio), the sag performance appeared to improve from m=1.0 to m=0.3. Too much KH₂PO₄ appears to be detrimental to the sag performance. Although not wishing to be bound by theory, this may be because the KH₂PO₄ is very water soluble and not all of it is reacted in the coating.

The addition of water (i.e., a higher water/solids ratio) at a given m value appeared to affect sag performance negatively. However, the sample at a high water/solids ratio of 1.5 and with m=0.3 performed very well.

It appears that by using a low value of m (m=0.3) and a medium water/solids ratio (W/S=1.0) it is possible to achieve acceptable sag resistance at a coating solids level of 20-25 g/ft².

### Example 7

The use of an acid in the formulations was evaluated. MgO (MagChem 10 CR) was measured into a cup. The KH₂PO₄, water, and phosphoric acid were measured into a separate cup and stirred to dissolve the phosphate. The solid MgO was added to the water phosphate solution and mixed. The temperature rise of the mixture was measured using a thermocouple. The coatings were allowed to dry. The mixtures are shown in Table 8.

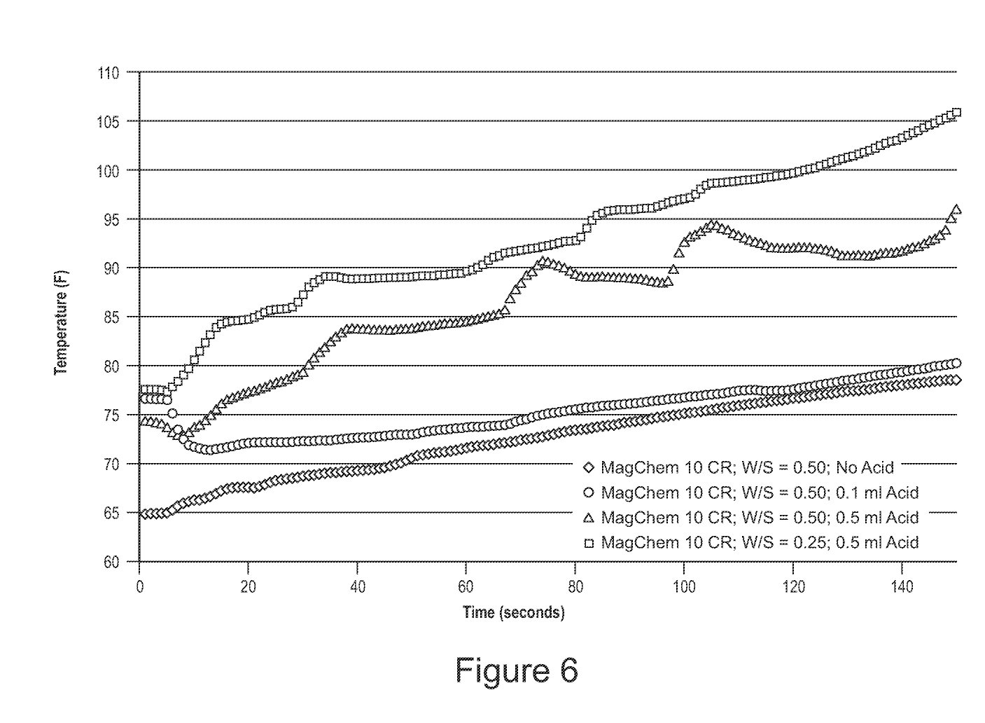

In Trial 1, MagChem 10 CR was used, with m=0.3, and W/S=0.50 and no acid added and where “m” refers to the molar ratio of KH₂PO₄ to MgO and W/S refers to the water/solids ratio. There was no apparent reaction after 2 minutes and the reaction product was softer. This is possibly due to the presence of too much water. Trial 2 used MagChem 10 CR with m=0.3, W/S=0.50, and 0.1 ml 85% H₃PO₄ added. There was a slightly more rapid and a softer reaction product. Trial 3 used MagChem 10 CR with m=0.3, W/S=0.50, and 0.5 ml 85% H₃PO₄ added. There was a very rapid reaction with steam generation. Trial 4 used MagChem 10 CR with m=0.3, W/S=0.25, and 0.5 ml 85% H₃PO₄ added. There was a very rapid reaction with steam generation and a hard reaction product. The results of Trials 1-4 are shown in FIG. 6.

The phosphoric acid can accelerate the reaction with slower reacting MgO materials.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

TABLE 1

| | | Wt. | | | | Ratio |
|---|---|---|---|---|---|---|
| Trial | | of | Wt. of | Wt. of | calc. | Water |
| # | MgO Source | MgO | KH₂PO₄ | Water | “m”* | to Solids |
| 1 | MagChem 10 CR | 10.0 | 10.1 | 10.1 | 0.30 | 0.50 |
| 2 | MagChem 30 | 10.0 | 10.1 | 10.1 | 0.30 | 0.50 |
| 3 | Baymag 30 | 10.0 | 10.1 | 10.1 | 0.30 | 0.50 |
| 4 | Baymag 40 | 10.0 | 10.1 | 10.1 | 0.30 | 0.50 |
| 5 | MagChem 10 CR | 10.0 | 10.1 | 20.1 | 0.30 | 0.25 |

*“m” refers to the molar ratio of KH₂PO₄ to MgO

TABLE 2

| | Wt of | Wt of | Wt. of | KH₂PO₄/MgO | Percent | Max Temp | Temp Rise | |
|---|---|---|---|---|---|---|---|---|
| Trial # | KH₂PO₄ | MgO | Water | Ratio* | Solids | (° F.) | (° F.) | Slope |
| 1 | 3.0 | 5.00 | 5.0 | 0.6 | 61.5% | 104 | 33.1 | 0.80 |
| 2 | 3.0 | 5.00 | 10.0 | 0.6 | 44.4% | 89 | 15.6 | 0.09 |
| 3 | 3.0 | 5.00 | 15.0 | 0.6 | 34.8% | 97 | 13.8 | 0.05 |

*weight ratios

TABLE 3

| Trial | Wt. of | | Wt of | Wt of | KH₂PO₄/MgO |
|---|---|---|---|---|---|
| # | KH₂PO₄ | Thickener | MgO | Water | Ratio* |
| 1 | 3.0 | None | 5.00 | 5.0 | 0.60 |
| 2 | 3.0 | 0.5% Bentone GS | 5.00 | 5.0 | 0.60 |
| 3 | 3.0 | 1.0% Bentone GS | 5.00 | 5.0 | 0.60 |

*weight ratio

TABLE 4

| | Wt. of | Wt. of | | Wt. of | Wt. of | |
|---|---|---|---|---|---|---|
| Trial # | KH₂PO₄ | Water | Thickener | MgO | Water | Wt. of Filler |
| 1 | 10.0 | 6.00 | 2.0% Bentone GS | 10.00 | 8.00 | 0.0 |
| 2 | 10.0 | 6.00 | 2.0% Bentone GS | 10.00 | 10.00 | 10.0 (33% Type C fly ash filler) |
| 3 | 10.0 | 6.00 | 2.0% Bentone GS | 10.00 | 14.00 | 20.0 (50% Type C fly ash filler) |
| 4 | 10.0 | 6.00 | 2.0% Bentone GS | 10.00 | 17.00 | 40.0 (67% Type C fly ash filler) |

TABLE 5

| | Solution A | | | | Solution B | | | |
|---|---|---|---|---|---|---|---|---|
| | Wt. of | Wt. of | | Ml of 85% | Wt. of | Wt. of | Wt. of | Calculated |
| Trial # | KH₂PO₄ | Water | Thickener | H₃PO₄ | MgO | Water | Filler | pH |
| 1 | 10.0 | 6.00 | 2.0% Bentone GS | 0.0 | 10.00 | 10.00 | 20.0 | 3.21 |
| 2 | 10.0 | 6.00 | 2.0% Bentone GS | 0.5 | 10.00 | 10.00 | 20.0 | 1.14 |

TABLE 6

| | | | | | Ratio | | |
|---|---|---|---|---|---|---|---|
| | | | | | of | | |
| | | | Wt. | | Water | | |
| | Wt. of | Wt. of | of | MgO | to | calc | Percent |
| Trial# | KH₂PO₄ | Water | MgO | Type | Solids | “m” | Solids |
| 1 | 60.8 | 72.5 | 60.0 | Baymag | 0.60 | 0.30 | 62.5% |
| | | | | 30 | | | |
| 2 | 87.8 | 76.7 | 40.0 | Baymag | 0.60 | 0.65 | 62.5% |
| | | | | 30 | | | |
| 3 | 101.3 | 78.8 | 30.0 | Baymag | 0.60 | 1.00 | 62.5% |
| | | | | 30 | | | |
| 4 | 50.6 | 105.7 | 50.0 | Baymag | 1.05 | 0.30 | 48.8% |
| | | | | 30 | | | |
| 5 | 65.8 | 100.6 | 30.0 | Baymag | 1.05 | 0.65 | 48.8% |
| | | | | 30 | | | |
| 6 | 67.5 | 91.9 | 20.0 | Baymag | 1.05 | 1.00 | 48.8% |
| | | | | 30 | | | |
| 7 | 40.5 | 120.8 | 40.0 | Baymag | 1.50 | 0.30 | 40.0% |
| | | | | 30 | | | |
| 8 | 54.9 | 119.8 | 25.0 | Baymag | 1.50 | 0.65 | 40.0% |
| | | | | 30 | | | |
| 9 | 67.5 | 131.3 | 20.0 | Baymag | 1.50 | 1.00 | 40.0% |
| | | | | 30 | | | |
| 10* | 65.8 | 100.6 | 30.0 | Baymag | 1.05 | 0.65 | 48.8% |
| | | | | 30 | | | |
| Totals | 596.8 | | 315.0 | | | | |

“m” refers to the molar ratio of KH₂PO₄ to MgO
*repeat of 5

TABLE 7
Sag Chamber Testing Data Sorted by Water/Solids Ratio

| | | | | | | Final |
|---|---|---|---|---|---|---|
| | | | | | | Position |
| | Net | Net | | | Final | Relative |
| | Dried | Dried | | | Total | to a |
| | Coating | Coating | Calculated | Ratio of | Move- | Flat |
| Sample | Weight | Weight | “m” | Water to | ment | Plane |
| Name | (g/panel) | (g/sf) | Value | Solids | (in) | (in) |
| 1 | 19.3 | 38.5 | 0.30 | 0.60 | 0.247 | 0.484 |
| 2 | 29.9 | 59.9 | 0.65 | 0.60 | 0.202 | 0.306 |
| 3 | 29.7 | 59.5 | 1.00 | 0.60 | 1.136 | 1.212 |
| 4 | 11.9 | 23.8 | 0.30 | 1.05 | 0.458 | 0.597 |
| 5 | 14.9 | 29.7 | 0.65 | 1.05 | 0.491 | 0.594 |
| 10 | 28.6 | 57.2 | 0.65 | 1.05 | 0.658 | 0.768 |
| 6 | 14 | 27.78 | 1.00 | 1.05 | 0.809 | 0.868 |
| 7 | 13 | 25.34 | 0.30 | 1.50 | 0.526 | 0.647 |
| 8 | 17 | 33.22 | 0.65 | 1.50 | 1.295 | 1.363 |
| 9 | 18 | 36.50 | 1.00 | 1.50 | 1.735 | 1.809 |
| 11 | na | 0.0 | 0.00 | 0.00 | 2.262 | 2.255 |
| 12 | na | 0.0 | 0.00 | 0.00 | 2.271 | 2.268 |
| 13 | na | 0.0 | 0.00 | 0.00 | 2.231 | 2.212 |
| 14 | na | 0.0 | 0.00 | 0.00 | 2.193 | 2.202 |
| 15 | na | 0.0 | 0.00 | 0.00 | 2.200 | 2.180 |

TABLE 8

| | Wt. of | Wt. of | Wt. of | Ml of 85% | calc. | calc. | |
|---|---|---|---|---|---|---|---|
| Trial # | MgO | KH₂PO₄ | Water | H₃PO₄ | pH | “m” | W/S |
| 1 | 10.0 | 10.0 | 10.0 | 0.0 | 3.17 | 0.30 | 0.50 |
| 2 | 10.0 | 10.0 | 10.0 | 0.1 | 1.59 | 0.30 | 0.50 |
| 3 | 10.0 | 10.0 | 10.0 | 0.5 | 1.25 | 0.30 | 0.50 |
| 4 | 10.0 | 10.0 | 5.0 | 0.5 | 1.25 | 0.30 | 0.25 |

“m” refers to the molar ratio of KH₂PO₄ to MgO
W/S refers to the water to solids ratio.

What is claimed is:

1. A method for making a building panel comprising:
combining water, an inorganic fiber, and one or more binders to form a slurry, wherein at least one of the binders comprises starch;
shaping the slurry into a panel;
applying a coating to a back side of the panel, the coating comprising a reaction product of magnesium oxide and a phosphate salt in the absence of an amino alcohol; and
drying the panel.

2. The method of claim 1 wherein the phosphate salt comprises at least one of potassium phosphate, and sodium phosphate.

3. The method of claim 1 wherein the magnesium oxide is a high reactivity magnesium oxide.

4. The method of claim 1 wherein a molar ratio of the magnesium oxide to the phosphate salt is in a range of about 0.1 to about 0.9.

5. The method of claim 1 wherein applying the coating to the back side of the panel comprises applying the coating over a portion of the back side of the panel.

6. The method of claim 1 wherein applying the coating to the back side of the panel comprises applying the coating over all of the back side of the panel.

7. The method of claim 1 wherein applying the coating to the back side of the panel comprises:
preparing a dispersion of the magnesium oxide;
preparing a dispersion of the phosphate salt; and
combining the magnesium oxide and phosphate dispersions and immediately applying the magnesium oxide dispersion and the phosphate salt dispersion to the back side of the panel.

8. The method of claim 8 further comprising adding an acid to at least one of the magnesium oxide dispersion and the phosphate salt dispersion.

9. The method of claim 1 wherein the coating further comprises at least one of a filler, a flow aid, and a retarder.

10. The method of claim 1 wherein the coating is applied in an amount of less than about 25 grams of solids per square foot.

11. The method of claim 1 wherein the slurry further comprises at least one of expanded perlite and a renewable fiber.

12. The method of claim 11 wherein the renewable fiber is cellulose fiber.

13. A building panel comprising;
a base mat comprising an inorganic fiber, and one or more binders, wherein at least one of the binders comprises starch;
a coating on a back side of the base mat, the coating being the reaction product of magnesium oxide and a phosphate salt.

14. The building panel of claim 13 wherein the phosphate salt comprises at least one of potassium phosphate, and sodium phosphate.

15. The building panel of claim 13 wherein the magnesium oxide is a high reactivity magnesium oxide.

16. The building panel of claim 13 wherein a molar ratio of the magnesium oxide to the phosphate salt is in a range of about 0.1 to about 0.9.

17. The building panel of claim 13 wherein the coating covers a portion of the back side of the panel.

18. The building panel of claim 13 wherein the coating covers all of the back side of the panel.

19. The building panel of claim 13 wherein the base mat further comprises at least one of expanded perlite and a renewable fiber.

20. The building panel of claim 13 wherein the coating is applied in an amount of less than about 25 grams of solids per square foot.
